(19) United States
(12) Patent Application Publication
(10) Pub. No.: US 2014/0112666 A1
(43) Pub. Date: Apr. 24, 2014

(54) MULTI-CHANNEL AND FEEDBACK-CONTROLLED LIGHT APPARATUS

(71) Applicant: Neng-Chen YEH, Tainan City (TW)

(72) Inventor: Neng-Chen YEH, Tainan City (TW)

(21) Appl. No.: 13/657,951

(22) Filed: Oct. 23, 2012

(51) Int. Cl. H04B 10/10

(52) U.S. Cl. 398/115

(57) ABSTRACT

A multi-channel and feedback-controlled light apparatus has a transmitter unit and a receiver unit. The transmitter unit sends out a wireless signal through at least one channel to the receiver unit. When the receiver unit receives the wireless signal, the receiver unit correspondingly sends a response signal back to the transmitter unit. If the transmitter unit does not receive the response signal, the transmitter unit will switch to new channels to send the wireless signal to the receiver unit at new channels until the transmitter unit receives the response signal. Therefore, the receiver unit can correctly receive the wireless signal and overcomes the signal missing problem induced by channel interferences. The light apparatus increases the wireless signal transmission effect.

### BACKGROUND OF THE INVENTION

1. Field of the Invention

The present invention relates to a light apparatus, and more particularly to a multi-channel and feedback-controlled light apparatus.

2. Description of Related Art

Wireless light control device is quite common nowadays. A wireless control device mainly comprises a transmitter module and a receiver module. The receiver module is electrically connected to a load device. The transmitter module is adapted to send out a wireless signal to the receiver module. When the receiver module receives the wireless signal, the receiver module activates the load device according to the wireless signal. Because the transmitter module wirelessly communicates with the receiver module without any cable, a user can use the wireless control device without considering or being limited by the layout of cables.

In general, the radio frequencies of the transmitter module and the receiver module should match to each other, such that the receiver module is able to receive the wireless signals sent from the transmitter module.

However, when an external device enters the wireless signal coverage of the conventional wireless control device, the wireless signal of the external device may interfere with the wireless signal of the transmitter module. As a result, the receiver module cannot correctly receive the wireless signal from the transmitter module and the use of the conventional wireless control device encounters obstacles.

### SUMMARY OF THE INVENTION

An objective of the present invention is to provide a multi-channel and feedback-controlled light apparatus. The apparatus makes sure that the receiver unit can correctly receive the wireless signal from the transmitter unit, such that the receiver unit does not miss the wireless signal.

The light apparatus of the present invention comprises a transmitter unit and a receiver unit.

The transmitter unit has a wireless module and a transmission controller. The transmission controller sends out a wireless signal according to a light driving signal through at least one channel via the wireless module. When the transmission controller does not receive a response signal after the transmission controller sends out the wireless signal, the transmission controller switches to at least one new channel to send out the wireless signal at the new channel until the transmission controller receives the response signal.

The receiver unit matches the transmitter unit and has a load circuit, a wireless module and a reception controller. The reception controller receives the wireless signal via the wireless module of the receiver unit and activates the load circuit according to the wireless control module. When the reception controller receives the wireless signal, the reception controller sends the response signal to the transmission controller.

The light apparatus of the invention has obvious advantages as described below:

1. Automatically confirm that the reception controller correctly receives the wireless signal from the transmitter unit:

Because the reception controller sends the response signal to the transmission controller as long as the reception controller receives the wireless signal from the transmission controller, the transmission controller makes sure that the reception controller correctly receives the wireless signal based on the response signal.

When the transmission controller does not receive the response signal, the reception controller may not have received the wireless signal. A possible reason is that the present channel is interfered. Hence, the transmission controller then switches to a new channel to send out the wireless signal again at the new channel. The transmission keeps executing the changing action to send out the wireless signals in the newly selected channel until the transmission controller receives the response signal from the reception controller.

As a result, according to the response signal, the light apparatus of the invention automatically does a feedback-checking action and a channel-switching action to confirm that the reception controller correctly receives the wireless signal from the transmitter unit. The light apparatus of the invention overcomes the problem that the conventional receiver module may miss the wireless signal from the transmitter module.

2. Increase the wireless signal transmission effect:

The light apparatus of the present invention can operate at different channels. When a presently used channel is under interference, the transmission controller can immediately and automatically switches to a new channel to send out the wireless signal again at the new channel. Furthermore, the transmission controller confirms that the reception controller correctly receives the wireless signal based on the response signal. As a result, the signal missing rate in the present invention decreases. Therefore, the wireless signals can be effectively transmitted from the transmitter unit to the receiver unit.

### BRIEF DESCRIPTION OF THE DRAWINGS

FIG. 1 is a circuit block diagram of the present invention;

FIG. 2A-2C are a detailed circuit diagrams of the transmitter unit of the present invention;

FIG. 3A-3D are detailed circuit diagrams of the receiver unit of the present invention; and

FIG. 4 is an operation diagram of the transmitter unit and the receiver unit of the present invention.

### DETAILED DESCRIPTION OF THE PREFERRED EMBODIMENT

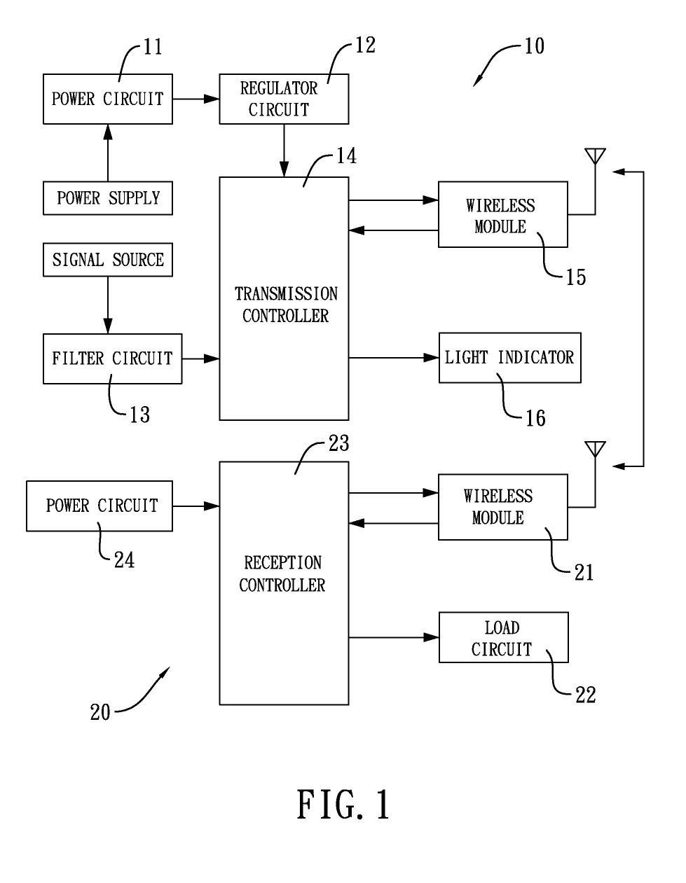

With reference to FIG. 1, a first embodiment of the present invention comprises a transmitter unit 10 and a receiver unit 20.

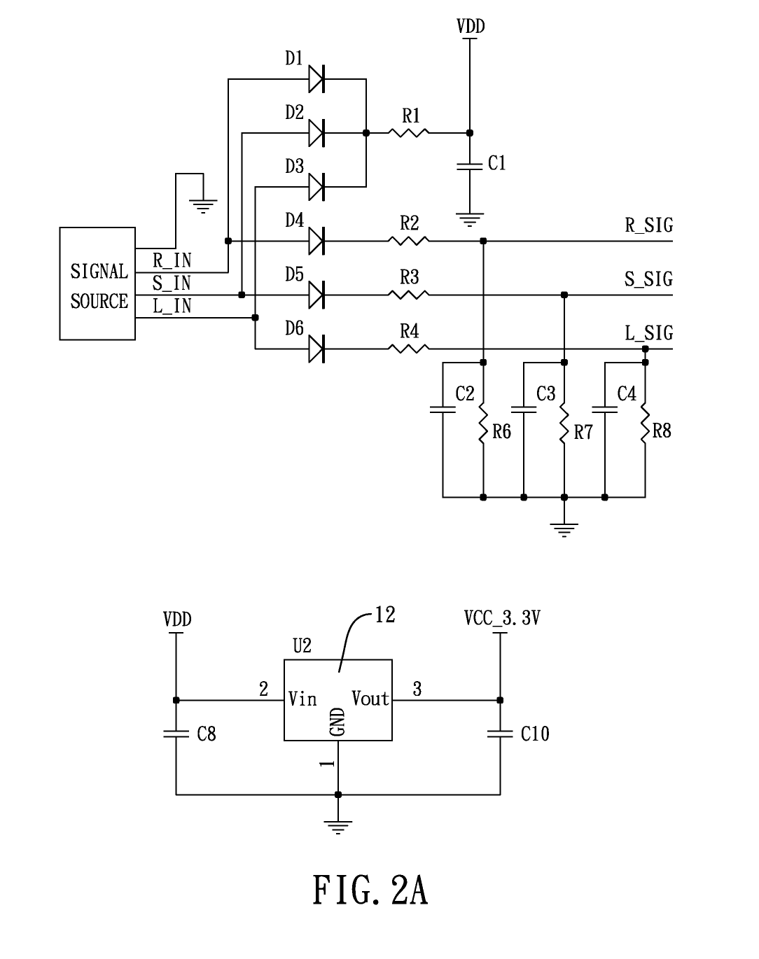

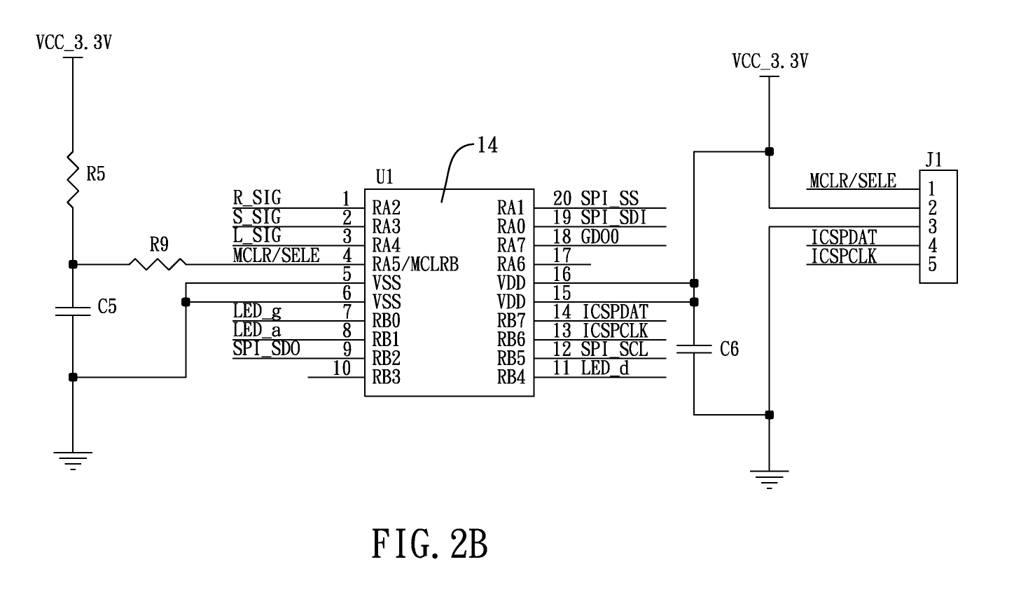

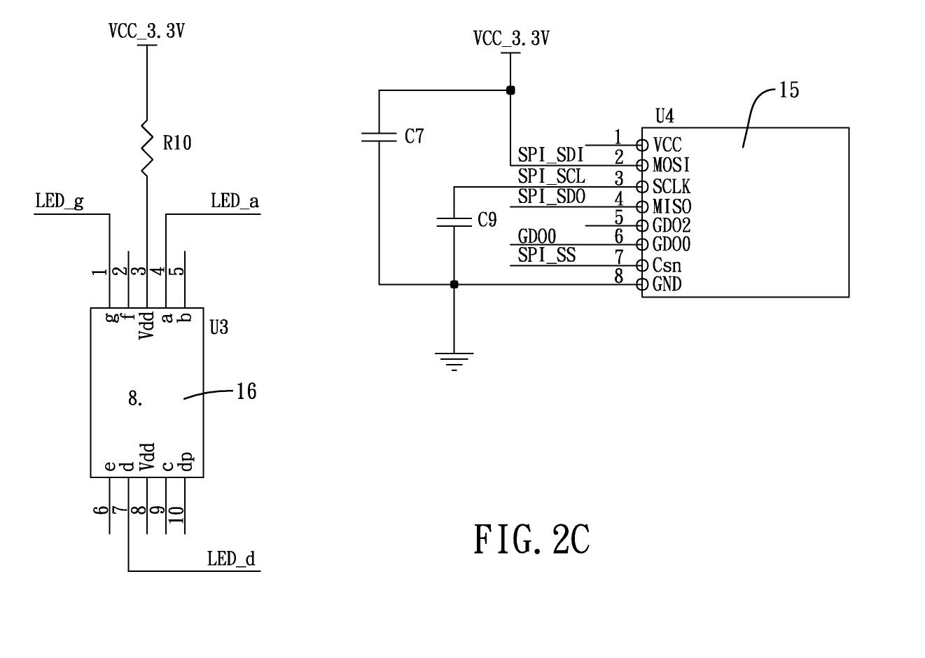

The transmitter unit 10 is adapted to be mounted on a host equipment, such as a truck. With reference to FIGS. 1 and 2A-2C, the transmitter unit 10 has a power circuit 11, a regulator circuit 12, a filter circuit 13, a transmission controller 14, a wireless module 15 and a light indicator 16.

The power circuit 11 is adapted to be connected to a power supply of the host equipment. The power circuit 11 receives a working voltage from the power supply of the host equipment.

The regulator circuit 12 has an input electrically connected to the power circuit 11 to receive the working voltage and regulates the working voltage. The regulator circuit 12 has an output electrically connected to the transmission controller 14 and the wireless module 15. The regulator circuit 12 provides the regulated working voltage to the transmission controller 14 and the wireless module 15.

The filter circuit 13 is electrically connected to a signal source of the host equipment. For example, the signal source can be a control system of the truck. The signal source generates a light driving signal for activating the lights of the truck. The filter circuit 13 responds for filtering noises from the light driving signal.

The light indicator 16 can be composed of seven-segment displays.

The transmission controller 14 is electrically connected to the filter circuit 13, the wireless module 15 and the light indicator 16. The transmission controller 14 receives the light driving signal from the filter circuit 13 and generates a wireless signal according to the light driving signal. The transmission controller 14 emits the wireless signal via the wireless module 15 through one channel or multiple channels. Each channel has a particular communication frequency.

The transmission controller 14 activates the light indicator 16 to display a symbol or number according to the light driving signal generated from the signal source. For example, when a user steps on a brake, the signal source generates the light driving signal indicating the braking action. The transmission controller 14 receives the light driving signal and activates the light indicator 16 to display “1” as an indication of the braking action.

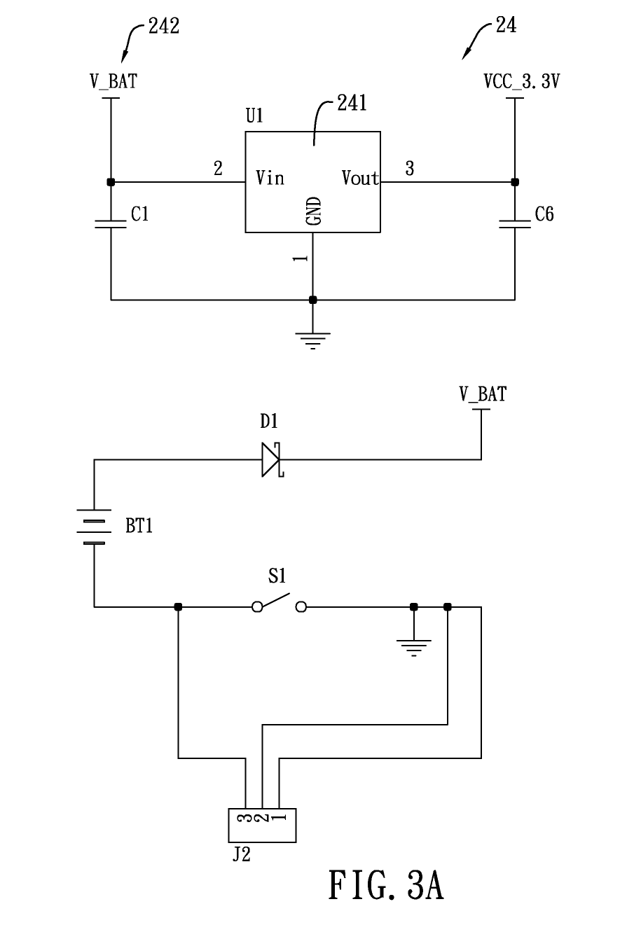

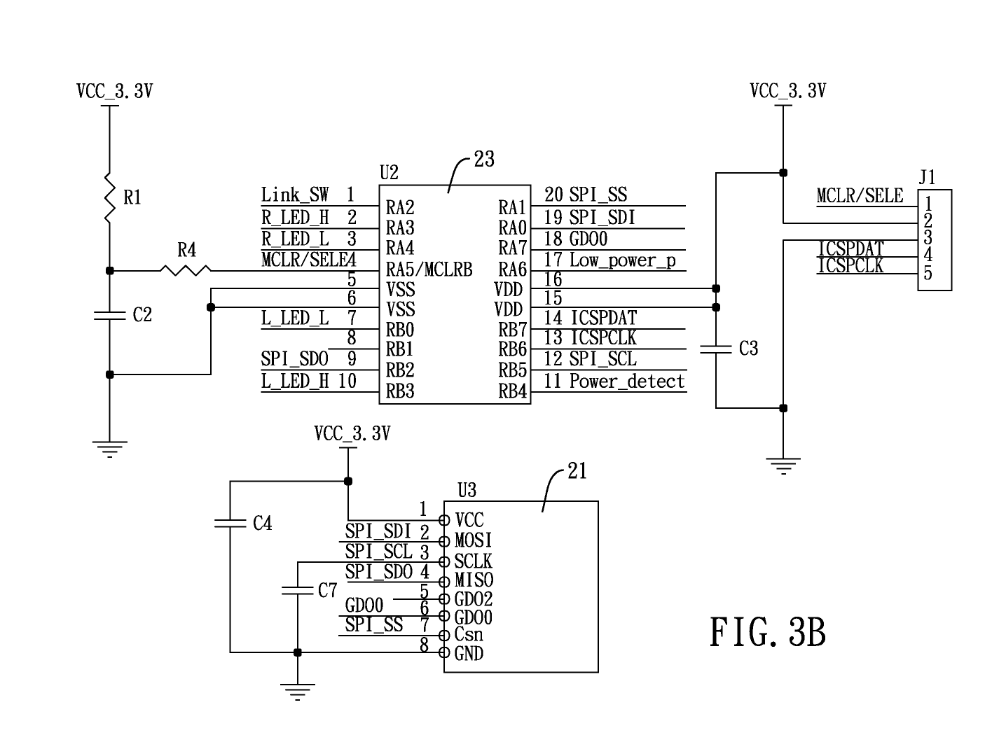

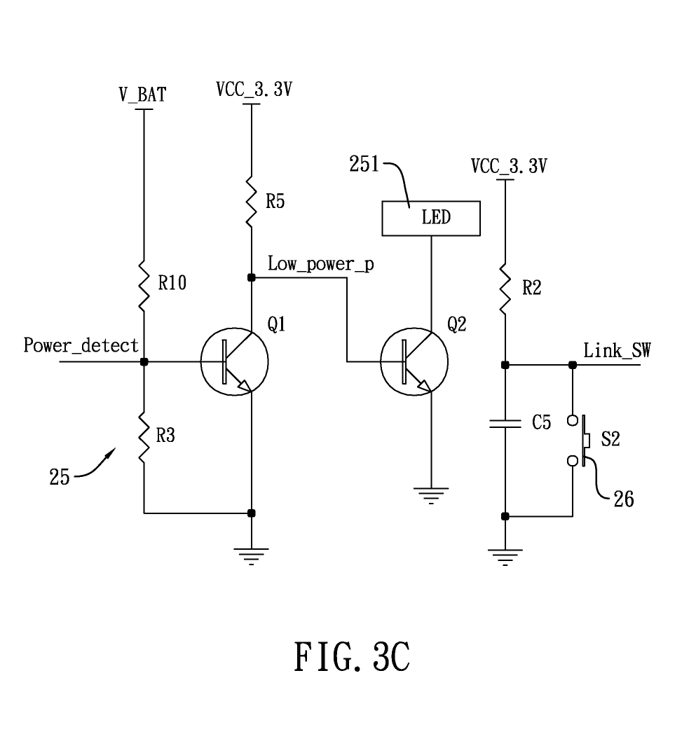

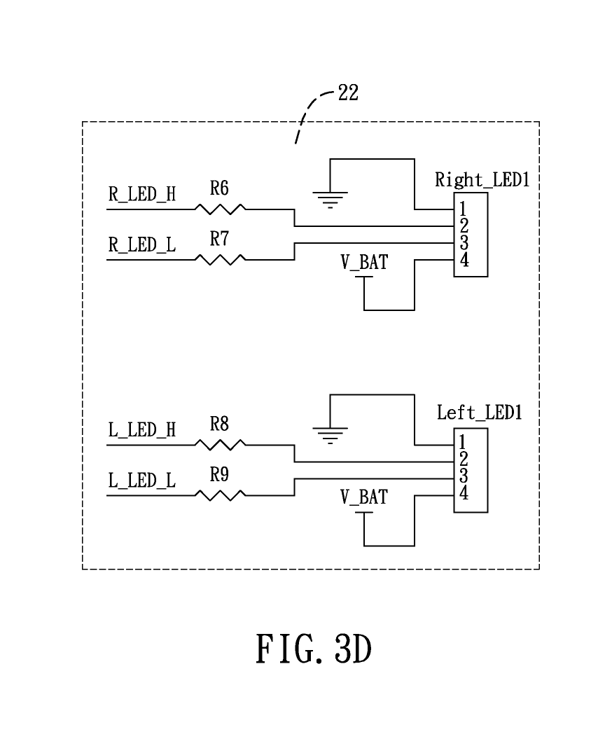

The receiver unit 20 is adapted to be mounted on a client equipment and matches the transmitter unit 10, such as a towed trailer connected behind the truck. With reference to FIGS. 1 and 3A-3D, the receiver unit 20 has a wireless module 21, a load circuit 22, a reception controller 23, a power circuit 24, a voltage detection circuit 25 and a registry button 26.

The load circuit 22 includes multiple LEDs (light emitting diode) and speakers.

The reception controller 23 is electrically connected to the wireless module 21 and the load circuit 22. The reception controller 23 receives the wireless signal generated from the transmitter unit 10 via the wireless module 21.

When the reception controller 23 receives the wireless signal, the reception controller 23 activates the load circuit 22 according to the wireless signal. For example, the load circuit 22 has a warning LED mounted on the back of the towed trailer. When the transmitter unit 10 generates the wireless signal for the braking action as mentioned above, the reception controller 23 activates the warning LED for indicating the braking action.

The power circuit 24 is electrically connected to the wireless module 21, the load circuit 22 and the reception controller 23 to provide a DC working voltage for them. In this embodiment, the power circuit 24 has a regulator 241. The regulator 241 has an input adapted to be connected to a battery 242 or an external power supply. The regulator 241 converts a voltage from the battery 242 or the external power supply to the DC working voltage, such as DC3V.

The voltage detection circuit 25 is electrically connected to the reception controller 23 and an input pin and output pin of the regulator 241. The voltage detection circuit 25 has a first electric switch Q1, a second electric switch Q2 and an LED 251. When the potential of the battery 242 is not enough to activate the first electric switch Q1, the first electric switch Q1 is turned OFF. The second electric switch Q2 is then turned ON to activate the LED 251. Therefore, the lighted LED 251 indicates that the battery 242 is running out soon.

The registry button 26 is electrically connected to the reception controller 23. When the registry button 26 is activated, the reception controller 23 receives the wireless signal through the wireless module 21 in the air from the transmitter unit 10. The wireless signal has a recognition code. When the reception controller 23 receives the wireless signal, the reception controller 23 registers the recognition code.

Therefore, when the reception controller 23 receives any wireless signal afterward, the reception controller 23 determines whether the wireless signal is generated from the transmitter unit 10 based on the recognition code. If the wireless signal is from the transmitter unit 10, the reception controller 23 activates the load circuit 22 according to the wireless signal. If the wireless signal is not from the transmitter unit 10, the reception controller 23 does not execute any action.

The operating instance mentioned above is just an illustrative example. In practice, users can set the transmitter unit 10 and the receiver unit 20 at any equipment of interest to them.

When the reception controller 23 receives the wireless signal from the transmitter unit 10, the reception controller 23 not only activates the load circuit 22, but also sends a response signal back to the transmission controller 14 via the wireless module 21. When the transmission controller 14 receives the response signal, the transmission controller 14 confirms that the reception controller 23 correctly receives the wireless signal.

The wireless signal generated from the transmitter unit 10 may be interfered by external transmission devices which use channels at the same or approximate frequency as the channel that the transmitter unit 10 uses. The receiver unit 20 then cannot receive the wireless signal, such that the reception controller 23 cannot activate the corresponding load circuit 22.

Because the reception controller 23 does not receive the wireless signal, the reception controller 23 does not send the response signal to the transmitter unit 10. Therefore, the transmission controller 14 does not receive the response signal after the transmission controller 14 sends out the wireless signal. The transmission controller 14 cannot confirm whether the reception controller 23 receives the wireless signal or not.

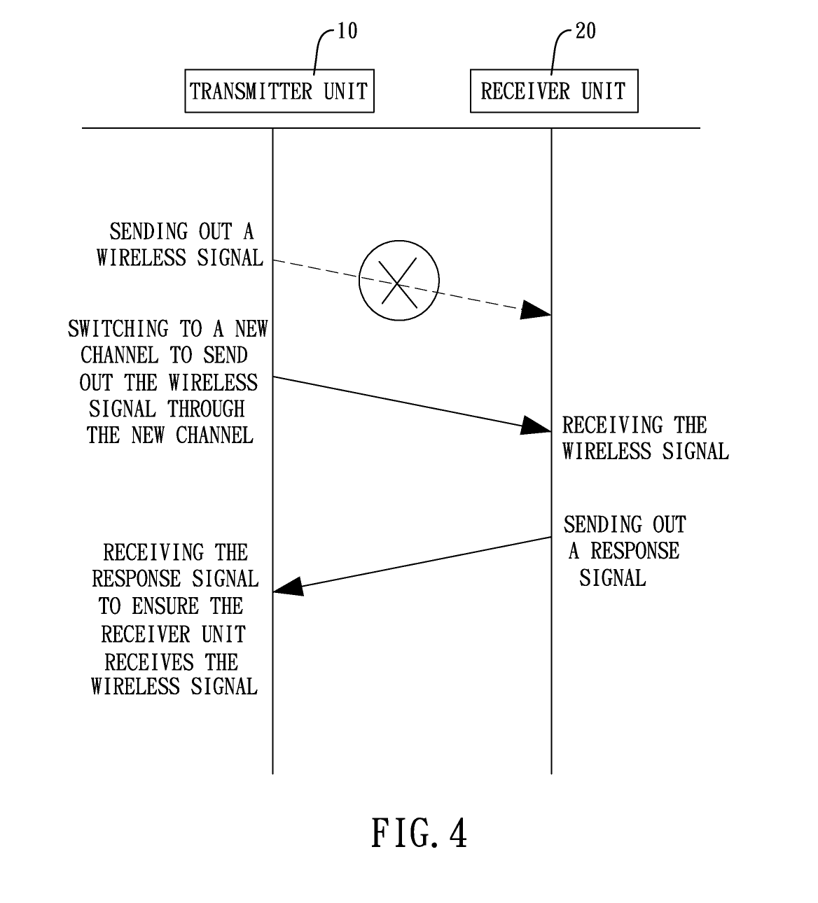

With reference to FIG. 4, when the transmission controller 14 does not receive the response signal, the transmission controller 14 sends out the wireless signal through other channels.

For example, when the transmission controller 14 does not receive the response signal after the transmission controller 14 sends out the wireless signal at a first channel, the transmission controller 14 switches to use a second channel to replace the first channel and sends out the wireless signal at the second channel.

For another example, when the transmission controller 14 does not receive the response signal after the transmission controller 14 operates at several channels including a first channel, a second channel, a third channel, a fourth channel and a fifth channel, the transmission controller 14 than switches to use new channels, including a sixth channel, a seventh channel, an eighth channel, a ninth channel and a tenth channel, to send out the wireless signal at the new channels.

If the transmission controller 14 still does not receive the response signal, the reception controller 23 probably does not correctly receive the wireless signal. The transmission controller 14 then switches to new channels again to send out the wireless signal at new channels until the transmission controller 14 receives the response signal from the reception controller 23.

In conclusion, the reception controller 23 sends the response signal to the transmission controller 14 after the reception controller 23 receives the wireless signal. The transmission controller 14 makes sure that the reception controller 23 correctly receives the wireless signal according to the response signal. If the transmission controller 23 does not receive the response signal, the transmission controller 23 will keep sending out the wireless signal at different channels until the transmission controller 14 receives the response signal from the reception controller 23, such that the reception controller 23 can correspondingly activate the load circuit 22 according to the light driving signal generated from the host equipment all the time.

What is claimed is:

1. A multi-channel and feedback-controlled light apparatus comprising:
a transmitter unit having:
a wireless module; and
a transmission controller sending out a wireless signal according to a light driving signal through at least one channel via the wireless module; wherein when the transmission controller does not receive a response signal after the transmission controller sends out the wireless signal, the transmission controller switches to at least one new channel to send out the wireless signal at the new channel until the transmission controller receives the response signal; and
a receiver unit matching the transmitter unit and having:
a load circuit;
a wireless module; and
a reception controller receiving the wireless signal via the wireless module of the receiver unit and activating the load circuit according to the wireless control module; wherein when the reception controller receives the wireless signal, the reception controller sends the response signal to the transmission controller.

2. The light apparatus as claimed in claim 1, wherein the receiver unit has a power circuit electrically connected to the wireless module of the receiver unit and the reception controller for providing a DC working voltage.

3. The light apparatus as claimed in claim 2, wherein the power circuit of the receiver unit has a regulator with an input electrically connected to a battery.

4. The light apparatus as claimed in claim 1, wherein the transmitter unit has a filter circuit electrically connected to the transmission controller to filter noises from the light driving signal.

5. The light apparatus as claimed in claim 2, wherein the transmitter unit has a filter circuit electrically connected to the transmission controller to filter noises from the light driving signal.

6. The light apparatus as claimed in claim 3, wherein the transmitter unit has a filter circuit electrically connected to the transmission controller to filter noises from the light driving signal.

7. The light apparatus as claimed in claim 1, wherein
the transmitter unit has a light indicator electrically connected to the transmission controller; and
the transmission controller activates the light indicator according to the light driving signal.

8. The light apparatus as claimed in claim 2, wherein
the transmitter unit has a light indicator electrically connected to the transmission controller; and
the transmission controller activates the light indicator according to the light driving signal.

9. The light apparatus as claimed in claim 3, wherein
the transmitter unit has a light indicator electrically connected to the transmission controller; and
the transmission controller activates the light indicator according to the light driving signal.

10. The light apparatus as claimed in claim 4, wherein
the transmitter unit has a light indicator electrically connected to the transmission controller; and
the transmission controller activates the light indicator according to the light driving signal.

11. The light apparatus as claimed in claim 5, wherein
the transmitter unit has a light indicator electrically connected to the transmission controller; and
the transmission controller activates the light indicator according to the light driving signal.

12. The light apparatus as claimed in claim 6, wherein
the transmitter unit has a light indicator electrically connected to the transmission controller; and
the transmission controller activates the light indicator according to the light driving signal.

13. The light apparatus as claimed in claim 7, wherein the light indicator includes a seven-segment display.

14. The light apparatus as claimed in claim 8, wherein the light indicator includes a seven-segment display.

15. The light apparatus as claimed in claim 9, wherein the light indicator includes a seven-segment display.

16. The light apparatus as claimed in claim 10, wherein the light indicator includes a seven-segment display.

17. The light apparatus as claimed in claim 11, wherein the light indicator includes a seven-segment display.

18. The light apparatus as claimed in claim 12, wherein the light indicator includes a seven-segment display.

19. The light apparatus as claimed in claim 1, wherein the load circuit includes an LED.

20. The light apparatus as claimed in claim 2, wherein the load circuit includes an LED.
